(19) United States
(12) Patent Application Publication
(10) Pub. No.: US 2020/0058019 A1
(43) Pub. Date: Feb. 20, 2020

(54) VIEWER DATA ACCESS MANAGEMENT

(71) Applicant: Free Stream Media Corporation d/b/a Samba TV, San Francisco, CA (US)

(72) Inventors: Ashwin Navin, San Francisco, CA (US); David Harrison, Daly City, CA (US)

(21) Appl. No.: 16/540,576

(22) Filed: Aug. 14, 2019

Related U.S. Application Data
(60) Provisional application No. 62/764,776, filed on Aug. 16, 2018.

(51) Int. Cl. G06Q 20/36; G06F 16/27; G06F 16/23

(52) U.S. Cl. CPC G06Q 20/3678; G06F 16/27; G06Q 2220/00; H04L 2209/56; G06F 16/2379

(57) ABSTRACT

Approaches presented herein provide for the management of viewership data, including contractual terms and transaction history, through immutable distributed ledgers, such as blockchain. Temporary identifiers can be used to store viewership data for a viewer to one of these public, distributed ledgers. A physical device identifier is associated with a media device. An identity manager generates and rotates temporary public identifiers that are mapped to the physical identifier of the device. Viewership data from the device and the related temporary identifiers are stored on the public distributed ledger. The identity manager receives a contract to provide viewership data of media device over a particular period. The identity manager supplies the temporary identifiers of the media device over the period specified. Upon fulfillment of the contract, the identity manager rotates the temporary identifier associated with physical device to ensure that prior temporary identifiers are no longer mapped to the same physical device identifier. The terms of the contract and subsequent viewership data are stored on the distributed ledger.

### CROSS-REFERENCE TO RELATED APPLICATIONS

This application claims priority to U.S. Provisional Application No. 62/764,776 filed Aug. 16, 2018 entitled “VIEWER DATA ACCESS MANAGEMENT,” which is hereby expressly incorporated herein by reference in its entirety.

### BACKGROUND

As electronic devices become increasingly sophisticated, people are using such devices to view and consume content at greater rates. Accordingly, there is an increasing demand for viewership data with respect to the increasing amount of content. In many instances, however, viewers are not comfortable providing that data to third parties, and have little to no control over which data is shared.

### BRIEF DESCRIPTION OF THE DRAWINGS

Various embodiments according to the present disclosure will be described with reference to the drawings, in which:

FIG. 1 illustrates an exemplary system that may be used to implement aspects of the various disclosed embodiments.

FIG. 2 illustrates an exemplary system for identifying viewership data that may be used according to various disclosed embodiments.

FIG. 3 illustrates exemplary information that may be contained within a distributed public ledger according to various disclosed embodiments.

FIG. 4 illustrates components of an exemplary system for presenting content that may be used according to various embodiments.

FIG. 5 illustrates an exemplary system for managing viewer wallets that may be used according to various disclosed embodiments.

FIG. 6 illustrates an exemplary currency flow that may be used according to various disclosed embodiments.

FIG. 7 illustrates a diagram of an example process that may be implemented according to certain example embodiments.

### DETAILED DESCRIPTION

Systems and methods in accordance with various embodiments of the present disclosure may overcome deficiencies experienced in conventional approaches to data control where users have little to no control over their data. Various disclosed embodiments enable unparalleled user and consumer control, visibility and incentives for privacy-compliant sharing of their viewing data with third party entities, such as content providers, broadcasters, and advertising agencies.

In various embodiments, consumer devices such as televisions, monitors, wearable devices, smart phones, tablets, handheld gaming devices, and the like may include display elements (e.g., display screens or projectors) for displaying consumer content. This content may be in the form of television shows, movies, live or recorded sporting events, audio, video games, and the like. Typically, the consumer devices are agnostic or unaware of the type of content being rendered, but rather, merely operate to render and display the content as instructed. In various embodiments, the consumer devices may operate in tandem with other devices. For example, a television may be connected to a receiver, which may receive inputs from other devices such as set-top boxes, gaming systems, multimedia streaming devices, and the like, which the receiver routes to the television for display to the consumer.

In various embodiments, a consumer device may include an embedded chipset utilized to identify content being displayed on the user device, which may be referred to as Automatic Content Recognition (ACR). The chipset may be utilized to receive the content feed being transmitted to the user device, for example a streaming media feed or a feed from a set top cable box.

Furthermore, in various embodiments, the chipset may extract or otherwise identify certain frames from the media stream for later processing and recognition. Identification may be facilitated by using a fingerprint made up of a representation of features from the content. For example, software may identify and extract features and compress the characteristic components thereby enabling unique identification by the fingerprint. In various embodiments, a one-way hash of the fingerprint may be created. This hash may then be compared with a database of content to facilitate recognition. This database may include feature vectors and/or machine learning techniques to facilitate robust, quick matching. It should be appreciated that multiple fingerprints may also be utilized in the identification process. In various embodiments, the fingerprints may be related to individual frames or images and/or auditory segments.

While various embodiments may include an embedded chipset for performing ACR, in other embodiments, ACR may be performed without an embedded chipset. For example, ACR may be performed utilizing an application that may include software code stored on the display device or a second external user device. For example, if a user where watching content on a television, the user may incorporate a second user device, such as a smartphone, to take an image of the screen or receive a portion of audio from the content. Thereafter, the image or audio content may be utilized similarly as described above to identify the content displayed on the screen. The application may then provide recommended settings to the user, or via one or more communication protocols such as wireless internet or the like, may transmit instructions to the television to adjust one or more settings to enhance playback of the content.

In at least some embodiments, the viewership data obtained by these devices can be aggregated and provided to entities interested in such data. The aggregated data enables content viewership to be measured and analyzed in various ways. In addition to helping people discover new content through its recommendation algorithms integrated within various devices, approaches in accordance with various embodiments can utilize cryptocurrency-based approaches to empower viewers with unparalleled control, visibility, and incentives for privacy-compliant sharing of their viewing data with third party entities, such as content providers, broadcasters, and advertising agencies, among other such options. The data provided to these entities can provide significantly more insight than is otherwise available using conventional non-transparent ratings methodologies.

For example, TV and video consumption is worth more than $200 billion to advertisers globally, but consumers have never received any incentives or compensation for their attention to various instances of content, including shows, videos, streams, files, ads, and commercials. With a global media and advertising currency, approaches in accordance with various embodiments can allow for a decentralized marketplace enabling users to directly capitalize on their data, and decide who they want to sell it to. This provides a substantial improvement from today's environment where viewers have little visibility and control over the data. Such approaches can provide more value back to content consumers around the world.

As mentioned, the world is consuming more video than ever before. Outstripping the growth of all other forms of media combined, the amazing diversity of video creativity, growing production budgets for award winning shows, and flexibility to consume on any connected device anytime, anywhere, makes for a fantastic backdrop for continued growth. Much of the content that is enjoyed is created by numerous major media companies, emerging providers of streaming video and many millions of independent publishers all vying for a fraction of the viewers' attention.

Indeed, the sheer volume of content created everyday makes discovery a real challenge for independent and major producers alike. Entertainment producers spend billions of dollars worldwide to market their content (film, TV and streaming video) with the specific objective of being found and capturing a piece of our attention. Accordingly, viewers' attention is worth hundreds of billions of dollars to advertisers globally, which position their brands in the context of content that viewers find appealing enough to command a fraction of their time and attention.

Disclosed embodiments may utilize distributed computing to overcome the physical and technical barriers that inhibit media distribution and monetization. Use of a digital asset such as a cryptocurrency may put the consumer back in control of their data, provide secure privacy-compliant compensation for their attention, and give consumers real influence over the type of content that gets produced by major media companies, independent studios, or users themselves.

One example of such digital asset is referred to herein as a “video attention token” (VAT). A VAT may be a used as a method of payment that rewards content consumers for viewing content, sharing viewership data, or both. VAT may be created using Ethereum, EOS, or any other block-chain based platform. For example, each media player, may server as a node that may house copies of secure and decentralized ledger of viewership data of viewer devices authorized to write data onto the ledger. Such an approach may provide a comprehensive chronicle of content consumed by all viewers. It provides a census-level, anonymous ledger of content consumption ever created. The technology may be integrated within video players PCs, phones, tablets, and televisions, among other such devices, which are all platforms that can actively write to the ledger as result of their connectivity and embedded computing capable of cryptographic hash functions of viewership data and storing that data on the ledger.

In other embodiments, the video consumption data itself is not put in the ledger, but rather a notion of a View Verifier (VV) and Viewership Data Escrow (VDE) is utilized. The verifier may sign individual viewership data and may place in a data escrow to store the data that can later be sold to fulfill a smart contract placed in the ledger. The verifier may be an ACR provider.

To adopt, collect, and store tokens, a consumer may associate an Attention Wallet (AW) with a video player integrated with the ledger. Multiple wallets may be associated with the same player on a shared device like a TV. The wallet owner, however, may need to input a key (or other credential) or a secure code displayed on the player into the wallet from time to time to validate ownership of the wallet and transact on the VAT ecosystem.

A VAT can have numerous benefits to the consumer. First, it allows the consumer to carefully assess time spent watching video, which videos and genres consume the most amount of attention. Second, each token may be earned for every second of video consumed—a store of value that consumers may then use to pay video providers for more video. In doing so, providers may receive insights on what content consumers find most appealing, leading to content production based on granular consumer appetite. This direct feedback from the audience eliminates creative decisions that are made on pure gut instinct and it engenders more loyalty between providers and their audience. Third, data analytics run on the VAL and use of tokens provide more transparency to sponsors and advertisers that need precision in quantifying audiences to determine where to place their ads.

Video Attention Tokens have further benefits to consumers as an attempt to take back ownership and control of their data and identity online. Vast amounts of data are generated about viewership by every piece of technology used throughout the day. While viewers may believe this data collection is limited to a singular app, data travels and is increasingly transferable through data management platforms that broker exchange and enrichment of data across once proprietary silos. This data in aggregate triangulates everything about viewers, including where they live, what they do, what they watch, what their interests are, what they buy, and where they have been in highly precise terms. How this data gets used is often unknown by the consumers, because consumers typically do not read and understand the privacy policies that they accept, what lies behind blanket statements they agree to, and how data gets transmitted between parties without informed consent.

By using viewing platforms integrated with the VAL, viewership data may be anonymized and published into a pubic ledger with no identifiers attached. This eliminates proprietary and opaque measurement that is fragmented, inaccurate, biased, or surreptitious. It makes anonymous, aggregate viewership data available to everyone, providers and consumers alike. This transparency into viewership allows more efficient production investments, more confidence in advertising and sponsorship against the long-tail catalog, more equitable payments for talent, and more ultimately appealing content for consumers to choose.

If a commercial entity wishes to identify individual viewers and their viewership behavior, the entity may post a bid for identifying information in a marketplace that individual viewers can accept at their own discretion in exchange for VATs. The license to identifying information is governed by a smart contract that stipulates an additional token per second of viewership data, paid by the buying entity to the viewer who grants a perpetual, royalty-free license to the users identity appended to the viewership data. That license may be non-assignable, non-sub licensable and enforceable by any viewer or class of consumers. If buyers of data do not appear reputable, a consumer has no obligation to transact with them, and may remain entirely anonymous if they so choose. The only time any individual becomes identifiable is in establishing an AW or in licensing their data within a data marketplace. The data has value, and the individual viewer is in control of it

The tokens will have value for consumers. In one example, an hour of anonymous TV viewership may accrue 3,600 VATs in the user's wallet. If that hour occurs during a weeknight at primetime on broadcast TV, that viewer will have been exposed to 12 commercials on average, each fetching about $0.03 per viewer per advertiser ($0.36/hour). Furthermore, the vast majority of households in media markets like the United States, actually pay a cable TV provider (MVPD) about $60/month on average. If the average household consumes 4 hours of linear video per day, 120 hours per month, that viewership hour is worth another $0.50 in share of consumer payments. One online video streaming service boasts nearly an hour of streaming a day, for a $13/month subscription—roughly equivalent to $0.43/hour of consumer payments.

While watching YouTube, with one ad per 5 minutes of video, viewer attention is worth about $0.18 hour to advertisers, or $1.80/mo assuming 10 hours of use per month. In other words, for ad-supported television, the value of our attention is $0.86/hour, Netflix, $0.43/hour, and YouTube $0.18/hour. The average of those three is about $0.50/hour and the data underlying that media should be worth about 3% of the attention itself, so roughly $0.015/hour. To generate $1 of value, one must track 67 hours of video viewership, which by industry estimates across all screens and formats, occurs every week for the average consumer. That means, every month, the average consumer will be able to pay for about one movie rental for free using the value stored in their AW, and still be anonymous to commercial entities (other than the identity required to establish an AW). VATs may also be used to fund new video productions. A Marketplace will exist to fund film, TV shows, and independent video that meet with the interest of an individual viewer. For viewers who wish to sell their VATs instead of using them within a digital marketplace for video, markets will also emerge that allow for exchange of VATs for other cryptocurrencies or even fiat currencies.

In another embodiment, consumers are provided with fine grained access to the use of their data, with enforceable mechanisms. The consumers are also compensated or awarded an underwritten cryptocurrency. This can apply to various use cases in which valuable consumer data is generated. Consumers may earn tokens or coins by opting in to sharing their viewership data. Consumers may then spend the earned tokens or coins for rewards like free movie rentals on their TVs or they can use them elsewhere, exchange them for Bitcoin or other coins, etc. Unlike other cryptocurrencies, VATs are “underwritten” or pegged to the value of the viewership data and has a basic value to the consumer that it won't dip below (e.g., one coin will always be enough to at least rent a movie on the TV).

The viewership data may be signed by a central authority that vouches for its authenticity. A marketplace of viewership data may be established to enable data customer to find and purchase varying amounts of viewership data. In exchange, owners of that data would receive a predetermined amount of VATs as their data is sold. Consumers may also have access to fine-tuned privacy and sharing options for their data, such as different levels of access for their data (e.g., they can specify that their data can only be used in the aggregate or that they consent to be personally identified along with their data), blacklist or whitelist entities who may have their data (e.g., no porn companies, no political campaigns), permissible types of uses, etc. The consumers' preferences can be enforced by smart contracts stored on a blockchain.

An example ecosystem may include a distributed ledger (e.g., Ethereum blockchain), smart contracts, client applications (e.g., wallets), viewer devices, and user data. The currency, which can also be referred to as the VAT or any other coin for that matter, may be a native currency compatible with blockchain platforms such as Ethereum that support smart contracts. This can provide settlement and visibility to data-related transaction, as well as a fixed supply of tokens or coins, with no mechanism for increasing supply. Currency uses may include paying for data or buying digital goods and services, as well as to incentivize content views, including ads.

Content contracts, or smart contracts, may represent any consumed content in the ecosystem. Content may be television shows, ads, user generated video, etc. Each piece of content may receive a unique content ID, saved on a content registry. Content contracts accept user data from opted in users, and pass that user data and its own content onto the distribution contract which then “pays” the users for access to their data. A distribution contract collects all queryable data and distributes the currency to the data providers, e.g., users, media players, MVPD, and ACR companies. The distribution contract may also accept the currency in exchange for access to user-viewership data, creating a replenishable cycle of coins to pay out to users for their data. Other rules may be established in the distribution contract according to network needs.

Client applications, such as wallets, media players, ACR applications, and marketplaces, may provide users with a connection into VAT ecosystem. Wallets can facilitate the transfer of tokens or coins, update contracts, and provide a place to store earned tokens.

Media players and ACR can serve as trusted validators or verifiers of consumption information and may publish validated data to the chain. Marketplaces will establish storefronts or exchanges for digital content providers to sell their goods and services. Other applications may be created that will enable the direct in-view purchase of products, using the currency. Audio ACR may also allow for data authentication across multiple devices.

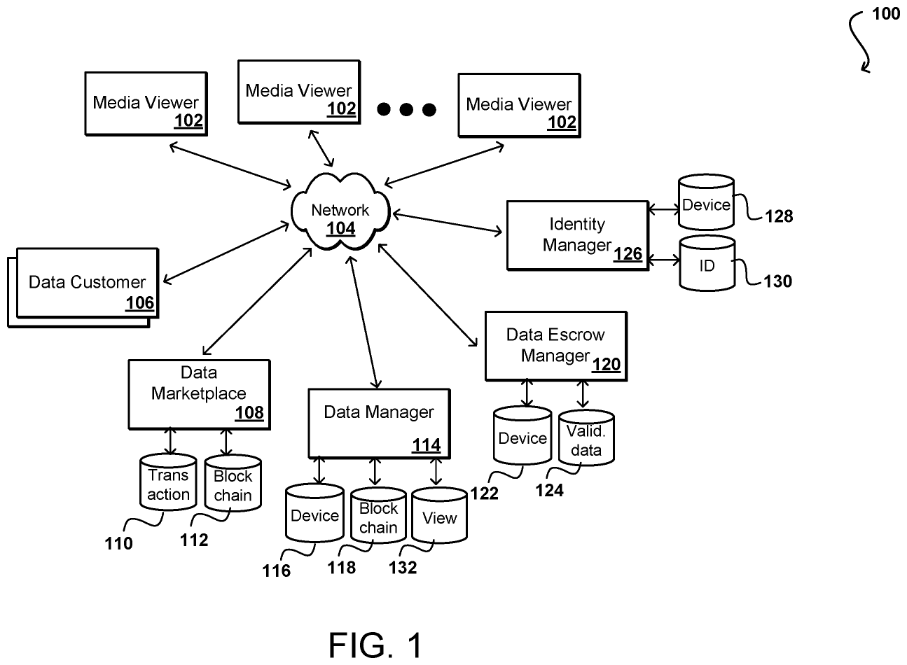

FIG. 1 illustrates an example system 100 that can be used to implement aspects of various embodiments. In this example, there can be multiple media viewer devices 102. These devices can include, for example, various types of portable computing devices, notebook computers, ultrabooks, tablet computers, mobile phones, desktop computers, personal data assistants, video gaming consoles, televisions, set top boxes, smart televisions, portable media players, wearable computers (e.g., smart watches, smart glasses, bracelets, etc.), display screens, displayless devices, other types of display-based devices, smart furniture, smart household devices, smart vehicles, smart transportation devices, and/or smart accessories, among others.

In this example, example data flows between various media devices, at least one network, and components of one or more systems or services will be described. It should be noted that additional services, providers, and/or components can be included in such a system, and although some of the services, providers, components, etc., are illustrated as being separate entities and/or components, the illustrated arrangement is provided as an example arrangement and other arrangements can be utilized as known to one skilled in the art are contemplated by the embodiments described herein. As an example, the identity manager 126 and data manager 114 might be provided by a single entity from a designated provider environment in some embodiments.

In this example, various media viewers 102 will each be able to provide at least some type of viewership data. As mentioned, this can include viewership data provided by hardware installed on the various viewers and associated with respective device identifiers in at least some embodiments. The information can be transmitted or otherwise obtained across at least one network 104, such as the Internet, a cellular network, a wired or wireless network, etc. The data can be received to a data manager 114 that can be able to aggregate and interpret the data in order to obtain viewership information for various devices, programming sources, instances of content, and the like. The data manager 114 in this example can track unique identifiers for each device, which may be stored locally in a device ID repository 116 or other such location. The viewership data can also be stored, individually or in aggregate, in a viewership repository 132 or other such location. The data manager can then perform various functions or analysis of the viewership data, such as to determine viewership patterns for a specific viewer or device, viewership data for a specific instance of content, a schedule of content provided by a specific content provider, etc.

In various embodiments, the viewership data, or analytics generated using that data, can be provided to a data customer 106, such as a third party content provider or advertiser. A data customer may be able to obtain specific types of data, such as viewership information relating to content provided by that customer. A data customer such as an advertiser may also be able to obtain viewership information for programming or content that is associated with advertising from that customer. Various other types of information may be available as well in different embodiments. In some embodiments the data may be associated with specific users or devices, while in others the data may be anonymous, or may only be available as aggregated, analyzed, or summarized by the data manager. In many instances, at least some of the data will only be available to third parties to the extent permitted by a user associated with a respective device from which viewership data is obtained. Often, this will be defined in the terms of use set forth and agreed upon with respect to the user. In many instances, however, the user will not read and/or understand the various terms, or would like more control over the use and availability of data obtained with respect to that user.

As mentioned, approaches in accordance with various embodiments can provide users or viewers with unprecedented levels of control over how their viewership data is used. This can include entering into specific agreements with one or more data customers 106 for specific data, such as may be in exchange for a specific type and/or amount of compensation. The agreement can be made through the data manager 114, client applications such as a wallet, or a data marketplace 108 in various embodiments. In one embodiment, a viewer can enter into a transaction with a data customer 106 through a data marketplace where the type of data and amount of compensation can be agreed upon. Terms for the agreement, or contract, can be agreed upon as well. These terms can then be used to govern the obtaining and use of the data, as well as to determine appropriate compensation to be provided for each unit of data provided, obtained, or utilized under the terms of the agreement.

As the number of users, data customers, and agreements increases, it can become difficult to track the various agreements and terms, and ensure that the most accurate and up-to-date terms are being followed. It can also be difficult to manage the terms and agreements, to ensure that there are no conflicts or misunderstandings, etc. Accordingly, approaches in accordance with various embodiments can utilize a distributed ledger approach to enable the terms of the contract, as well as information about specific transactions and amounts of compensation, to be contained within the ledger itself. This can utilize a technology such as blockchain wherein hashes of the prior versions of the chain are included in each individual block of the chain. Such an approach prevents changes to be made to information in prior blocks, or at least makes it clear when modifications to the chain have been made. Using such an approach, the terms of the agreement can be included in the ledger such that the terms will be available without modification or uncertainty.

A similar approach can be used to track the compensation provided. This can include compensation using digital or cryptocurrency in some embodiments, as may relate to bitcoin or Ethereum, among other such options. Transactions can be verified and recorded in a public distributed ledger, such as the same or a related blockchain as is used to store the terms of the agreement. A full history of compensation and transactions can then be contained in a single chain, or ledger, such that it can quickly be determined as to whether adequate compensation has been supplied under the terms of the agreement.

In order to ensure that a data customer 106 only receives data for which compensation has been provided under the agreement, the data can be associated with an identifier that is only valid for a determined period of time. In one embodiment, an entity such as an identity manager 126 can generate and rotate public identifiers that are mapped to the actual identifiers for specific users or devices. The actual identifiers in some embodiments correspond to GUIDs discussed elsewhere herein that are hard coded into respective media viewing devices 102. The GUIDs can be stored to a device ID repository 128 of the identity manager 126. The identity manager 126 can generate identities that can be provided to the data customer 106 or otherwise exposed for purposes of tracking or verification, but can the rotate, modify, delete, or disassociate these identifiers with the actual device identifiers such that the data customers can no longer obtain data for a specific device beyond that which was compensated as part of the agreement. The identity manager 126 can maintain the current public identifier, as well as potentially a history of identifiers, in an identity repository 130 that can be mapped to the corresponding device identifiers in the device repository 128, among other such ways of mapping and tracking the corresponding identifiers. Since ledgers such as blockchain can be used that are unable to be modified, the use of temporary identifiers enables the temporary identifier to be stored in a corresponding block of the blockchain, but such inclusion does not enable that identifier to subsequently be used to obtain or correlate data for that viewer outside the agreement as the temporary identifier will no longer be mapped to the same actual or physical device identifier.

In at least some embodiments, there can be a set of rules that have to be fulfilled by various parties to a transaction that go beyond just a conventional notion of a blockchain. For example, bitcoin is typically used as a currency without a notion or limitation of the type of items for which compensation could be provided as part of a related transaction. Approaches in accordance with various embodiments do not provide merely a transaction over a token or a coin, but take advantage of an entity such as a data manager 114 that is able to collect information to be provided to another entity, such as a data escrow manager 120, that is able to verify what a person is watching, or at least verify the content being presented via a specific device at a specific time. The viewership information can then, in at least some embodiments, be written back into the relevant blockchain or distributed ledger. As mentioned, an advantage of such a ledger is that it is very difficult to change once created or updated. As mentioned, the viewership data can then be written into a blockchain, for example, without including or revealing any identifying or personal information about the viewer or viewer device. In one embodiment, the entry would instead include some type of identifier indicating that a specific viewer or viewing device presented a specific instance or piece of content at a particular time. —The entry can also include information identifying an entity, such as an identity manager 126, who can verify the identity associated with the identifier. The entry in some embodiments can also include information identifying an entity, such as a data escrow manager 120, who is storing additional data pertaining to the viewership data. Such information enables a party such as a data consumer 106 to obtain verification of the identity per the contract, as well as to obtain additional data where permitted under the terms of the agreement.

The identification of a data escrow manager may be important in at least some embodiments as a data customer 106 may not be interested in pure viewership data alone. For example, the data customer 106 might want additional context data, such as may relate to a location of a particular viewer, demographics information, format information, and the like, at least where permitted and/or available per privacy laws and/or the terms of the contract. It may be desirable in at least some embodiments to keep such information outside of the blockchain, but make such information available to authorized parties having access to the relevant blockchain. Such an approach can provide a secure, unchangeable, verifiable history of watched events for a particular user or device.

As mentioned, the terms of the contract can be placed into the blockchain, or other distributed ledger, etc., along with the relevant data made available under those terms. It should be understood that separate but related chains or ledgers can be used as well within the scope of the various embodiments. In addition to the terms and the data, identifying information can be included for the identity manager 126 and data escrow manager 120, from whom authorized parties to the contract can obtain additional information that is not otherwise included in the relevant chain. Such an approach helps to ensure that the terms are always clear, unchanged, and available, and enables the relevant data to also be made available without requiring inclusion in the chain. Such an approach also enables the changing of identity associations over time such that a party having access to the blockchain will not be able to utilize the included data without an ability to also determine information about the viewer or device associated with that chain, or obtain additional information about the viewer or device, etc.

In at least some embodiments, transactions can also be performed using such a blockchain or ledger. A block could specify that one of the terms is that a certain amount of bitcoin (or Ethereum, VAT, or other cryptocurrency, for example) is to be paid for certain viewership data, and data for the transaction is then written into a subsequent block indication the transaction of compensation between specified entities. The fulfillment of the transaction can also be written into the blockchain.

In some embodiments, each of multiple entities can provide verification of information stored in a particular blockchain. For example, a data manager 114 might collect viewership information from various media viewers 102, and provide that information to an identity manager that can verify the information and sign (using a digital signature or certificate, for example) that a viewer associated with a specific identifier had specific content presented at a specific time. That verified data can then be transferred back to the data manager 114 or the respective user in some embodiments, as may be determined at least in part by the user. In other embodiments the validated viewership data can be sent to the data escrow manager 120 who can store the validated data in a respective repository 124, where the data can be made available to authorized parties to a transaction involving that data. In some embodiments the data manager 114 and data escrow manager 120 may be part of the same entity or offered by a single provider. A reference can also be written to the blockchain that indicates a location or entity from which the viewership data, or additional data, can be obtained.

The blockchain, or other distributed ledger or data structure, can then store the viewership (or other relevant) data, as well as the terms that apply to use of that data. Such an approach provides a user or viewer with a significant amount of control, as the user can determine the terms by which their data can be accessed and/or utilized, if at all. The terms can then be included in the blockchain such that they are not modifiable, at least without the modification be detectable. The user can determine how the data may be used, as well as the terms or compensation for such usage, where the compensation amounts may vary with the different types of usage. In some embodiments users can also select specific validators or escrow holders, or exclude such parties. In some embodiments a user or other party can also choose not to put the terms in the blockchain, or put the terms in a specified separate blockchain, among other such options. The user thus can have very granular control over their personal data. Further, if the terms of a user's contract are not met then the data will not be shared without explicit user approval.

In some embodiments the data marketplace 108 or another such entity may establish a market clearing price, which may be fixed or may vary over time. Such an approach can allow the market to decide the value of specific data. A user can then determine whether or not to expose some or all data based on the current market value, or expose certain data at market value then additional data only if the market value at least meets a specified minimum threshold. For example, a viewer might enable generic viewership data to be exposed for market price, such as data that content was viewed without any information as to the location, device, or viewer. When at least a minimum price threshold is met, the viewer may also enable additional data to be obtained with respect to the viewership data, such as geographic or demographic data. Data customers 106 may also be willing to pay a premium above market value to obtain such information, such as where the customer is attempting to determine viewership in a particular geographic region or market. In some embodiments the information may need to be verified, such as by a credit bureau for viewers purported to have a certain income level. Various other types of information can be made available as well for the same or different amounts, as may be specified by the terms in the blockchain. In some embodiments the data may be made available through an auction, where customers can bid for the data, and in some instances may have to pay at least a minimum price. While users may be able to set their own prices, there may need to be at least some amount of standardization in order to make the marketplace attractive to buyers. There might be some pricing guidelines in place, and then users may be able to determine whether or not to make that type of data available for the relevant price. And those prices could be fixed or could fluctuate, such as may be based upon current market demand. There may be special pricing for specific types of data, such as where a customer is looking for data for a specific region or demographic.

In some embodiments the data marketplace 108 and/or data manager 114, or another such entity, may provide some amount of market making. This may involve creating an initial set or number of contracts, in order to get users and customers to utilize the market. The entities can also ensure that compensation is being provided and the terms being met per the respective contracts. Such an approach also allows for the testing of different types of terms or compensation in order to determine the preferences of the market and to determine which approaches are successful and profitable.

In some embodiments the identity manager 126 may also be able to associate specific viewers with multiple devices or sources of viewership data. As mentioned, specific devices may have hardware or software installed that enable the viewership data to be obtained automatically, at least by the data manager 114. In some instances, multiple users can be associated with the same device, such as members of a household associated with a smart television. Each of those individuals may have other devices used to consume content as well, such as tablet computers, smart phones, media players, gaming consoles, and the like. Individuals may also utilize accounts to access content online or over one or more networks. If this information can be correlated, then viewership data for a given user can be obtained across multiple different sources. This data can then be made available separately or together, and may be associated with a single user wallet in some embodiments in which compensation for any of the data may be placed.

It should be understood that the terms may be set by any appropriate entity. As discussed in examples herein, a user or viewer can set the terms for which they will make their data available for certain use. Similarly, a data customer might set the terms by which they will provide compensation for such data, and a user can accept or reject those terms. A data marketplace or data manager may also provide terms in at least some embodiments, such as to standardize costs or terms across various entities. Various other options can be utilized as well as would be apparent to one of ordinary skill in the art in light of the teachings and suggestions contained herein. In order for data to qualify, all relevant terms must be satisfied in at least some embodiments, where the satisfaction of one or more terms may need to be validated by a mutually agreed upon validator, such as the identity manager 126 or another such validator discussed herein. Different validators may be used for different terms under the same contract as well. In some embodiments the data manager 114 may perform the role of validator, and may contract with different entities to obtain the information to be used for the verifications.

In some embodiments there may be restrictions on entities that can enter into such a contract as well. A data customer in some embodiments may need to be a signed, authenticated publisher of content. This can help to ensure that viewership data is protected, as well as to ensure that the blockchains do not become cluttered with irrelevant information. In setting up an account, a customer might need to go through a verification process using a designated validating entity. There may be criteria that need to continue to be satisfied by the entity, or periodic reverification may be required, in various embodiments. In some embodiments the type of verification required may depend at least in part upon the type of data requested and/or the intended use of that data.

In some embodiments the identity manager 126 might map identities for the data customers 106 in addition to the various users or viewers. This can help to protect the identity of the data customers, as well as to ensure that data for past transactions kept in the chain cannot be traced back to specific entities. The identity manager can store validating information for the entities, as may include a certificate of authority or other such credential. Such an approach can also help to standardize identities for various entities across the data environment. The mapped identifiers can be placed in the chain as discussed previously. The identities for the various identifiers can then only be obtained through identity resolution from the identity manager 126 or another such source. As mentioned, the identifiers can be rotated or modified periodically for privacy concerns, as well as to prevent the unauthorized use of data outside the terms of the relevant contracts.

As mentioned, and as illustrated in FIG. 1, there may be various types of blockchains in such a system that may be stored by, or accessible to, various entities. There may be separate blockchains or ledgers for viewership history, transaction history, compensation history, bid history, etc. There may also be blockchains that contain various combinations or subsets of this information. In various cases, there may be at least some identity mapping or obfuscation in the various blockchains for reasons including those discussed herein.

In some embodiments a compensation blockchain can be used to identify any unspent coins, or other digital currency, as well as the wallets that hold those coins. The wallets may only be identified by an identifier that is mapped to an actual wallet, such as by using approaches discussed herein. A current or mapped wallet identifier can be provided at time of transaction and/or compensation. The information in one or more blockchains may be used to determine wallets with unspent coins, but in order to determine the actual wallet one would need to be able to determine the mapped identity and verify permissions on the wallet. A wallet may be associated with a respective private key or other credential that can be used to verify ownership or access permission. When entering into a transaction, a party may sign a message or other object for each wallet that is holding money for this transaction, in order to prove that the party has the private key. A party can look at the blockchain to determine that unspent money exists, but the money cannot be taken by any party that does not have the private key. This enables proof of funds without unauthorized access to those funds or the wallets that hold those funds. As mentioned, there may also be links to a cryptocurrency blockchain instead of including the funds information in a primary transaction chain. In at least some embodiments the data manager 114 can store and/or manage the wallets holding funds for the relevant transactions and entities.

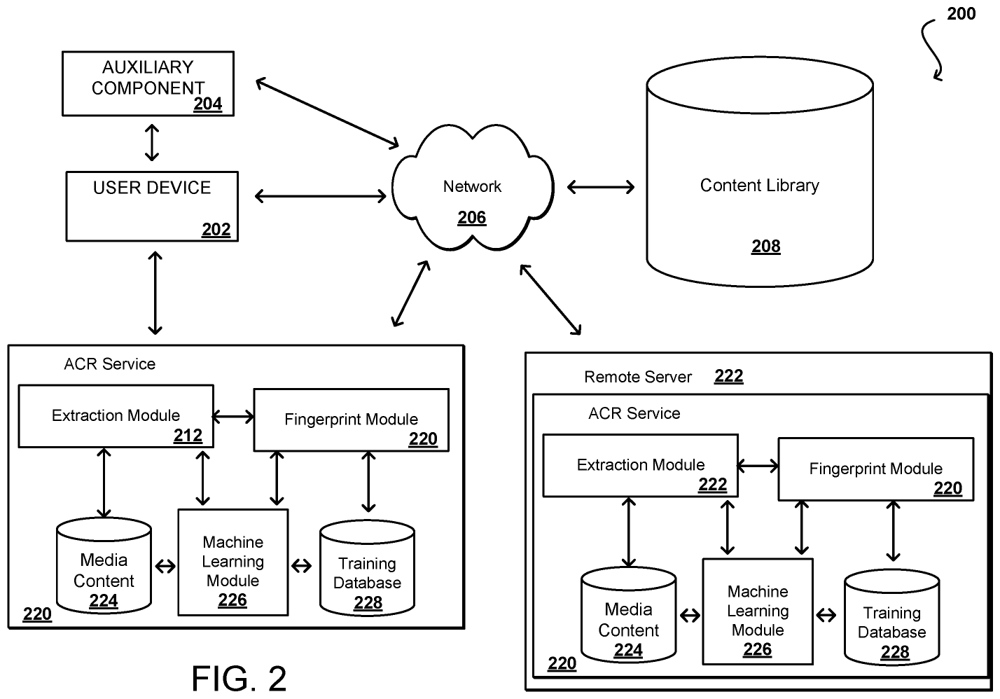

FIG. 2 illustrates an example system 200 that can be utilized to obtain and manage viewership information in accordance with various embodiments. The illustrated system 200 includes a single user device 202 and associated auxiliary components 204 for simplicity of explanation, but such a system can manage viewership and other data for multiple devices of various types as discussed and suggested elsewhere herein. As described above, an example user device 202 may include a television, personal computing device, laptop, tablet computer, or any other type of device. Furthermore, the auxiliary components 204 may include surround sound speakers, sound bars, set top cable boxes, streaming service boxes, and the like. The illustrated embodiment, the user device 202 and/or the auxiliary components 204 may be in communication with a network 206. The network 206 may be a configured to communicate with the user device 202 and/or the auxiliary components 204 via a wired or wireless connection. It should be appreciated that the network 206 may be an Internet or Intranet network that facilities communication with various other components that may be accessible by the network 206. In the illustrated embodiment, the network 206 communicatively couples the user device 202 to a content library 208. The content library 208 may represent one or more streaming services, television services, music services, or the like. Furthermore, while the illustrated embodiment shows the network 206 coupling the content library 208 to the user device 202, it should be appreciated that the content library 208 may be acquired via over-the-air or wired communication protocols, such as an antenna or a coaxial cable arrangement.

In various embodiments, the user device 202 may be equipped with an ACR service 210, such as via an embedded chipset, an application running on the user device 202, or the like. As described above, the ACR service 210 facilitates identification and fingerprinting of content rendered on the user device 202. For example, the ACR service 210 may include an extraction module 212 which is utilized to grab or otherwise obtain screen shots, video segments, auditory clips, or the like from the content displayed or otherwise utilized by the user device 202. The illustrated extraction module 212 is communicatively coupled to a media content database 224, which may include content available for consumption via the user device 202. The media content database 224 may be utilized in order to compare and identify the media content associated with the extracted information. For example, the media content database 224 may include screen shots or video capture segments from various content that can be evaluated and compared to the extracted information, for instance utilizing one or more machine learning or artificial intelligence techniques. In various embodiments, the media content database 224 may include particular segments from content, such as opening credits which enables robust matching. In other embodiments, the media content database 224 may include images or auditory samples from various actors associated with media content in order to identify or narrow down a range of potential matching content. It should be appreciated that in various embodiments the media content database 224 may not be integrated into the ACR service 220 and may be accessible via a remote server, as will be described below.

The illustrated ACR service 220 further includes a machine learning module 226. In various embodiments, the machine learning module 226 may obtain information from the extraction module 212, the media content database 214, a training database 228, or various other sources. The machine learning module 226 may include various types of models including machine learning models such as a neural network trained on the media content or previously identified fingerprints. Other types of machine learning models may be used, such as decision tree models, associated rule models, neural networks including deep neural networks, inductive learning models, support vector machines, clustering models, regression models, Bayesian networks, genetic models, various other supervise or unsupervised machine learning techniques, among others. The machine learning module 226 may include various other types of models, including various deterministic, nondeterministic, and probabilistic models. In various embodiments, the machine learning module 226 is utilized to quickly categorize and identify content associated with the extracted information. The neural network may be a regression model or a classification model. In the case of a regression model, the output of the neural network is a value on a continuous range of values representing potential content associated with the extracted information. In the case of a classification model, the output of the neural network is a classification into one or more discrete classes. For example, the output representing the extracted information may be classified as “sports”, “movie”, or “video game” with respect to the content associated with the extracted information. In various embodiments, as weight or confidence factor may be associated with the prediction or identification from the machine learning module 226. For example, a prediction with high confidence may receive a larger associated weight value than a prediction with low confidence.

In various embodiments, the ACR service 220 further includes a fingerprint module 220. The fingerprint module 220 may acquire information, for example from the machine learning module 226 or the extraction module 212 in order to identify the content associated with the user device 202. In the illustrated embodiment, the fingerprint module 220 transmits information to the training database 228. In various embodiments, the successfully identified fingerprints from the fingerprint module 220 may be utilized as ground truth information when training the model associated with the machine learning module 226. Accordingly, the associated ACR service 220 may be utilized to identify content rendered on the user device 202.

In the illustrated embodiment, a remote server 222 also incorporates the previously described ACR services. For example, in various embodiments the ACR service 220 may not be embedded within the user device 202, and rather, may be accessible via the network 206. Further, as described above, various components may not be incorporated as illustrated in FIG. 2 in all embodiments. For example, the ACR service 220 embedded within the user device 202 may include the extraction module 212, but may transmit the information, via the network 206, to the remote server 222 for further processing.

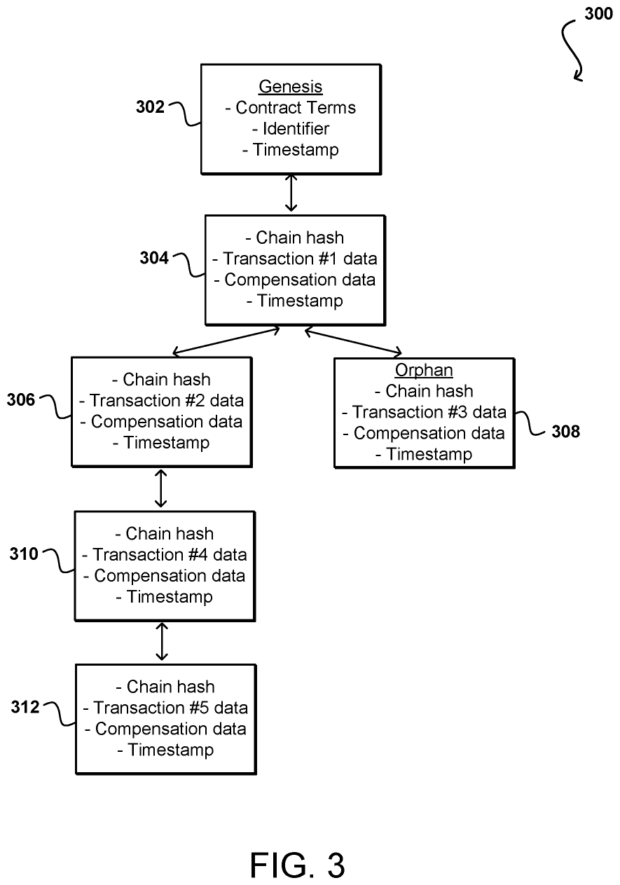

FIG. 3 illustrates an exemplary public transaction ledger 300 that may be used to implement various aspects of disclosed embodiments. In one embodiment, ledger 300 may be a distributed public ledger such as a blockchain that stores compensation, viewership, and VAT transactions in exemplary blocks 304-312. It should be understood that general principles of a blockchain technology allow for an indefinite amount of blocks to be appended to the chain; as such, block 312 may be superseded by several other blocks as the VAT ecosystem develops.

Indeed, ACRs within any user device or the user devices themselves may contain copies of the ledger and cryptographically write viewership data to new blocks. Alternatively, any viewer device such as a mobile phone, set-top box, computer, or television may similarly write viewership data to new blocks at predefined intervals.

Block 302, the first block in the ledger 302 (i.e., the Genesis block), may store several types of data including identifiers, smart contract terms of the protocol (i.e., VAT protocol), and timestamps. In one embodiment, the foundational contractual terms of the VAT protocol may also be stored in genesis block 302. The contract establishes the operational logic behind the protocol including, for example, what types of data may be shared, how compensation is distributed, what types of data may be stored, block producing devices, how disputes may be handled, etc.

In one embodiment, block 302 may programmatically specific the terms upon which a certain amount of bitcoin (or Ethereum, VAT, or other cryptocurrency, for example) is to be paid for certain viewership data. Once executed, transactional data may also be written into a subsequent block (e.g., block 304) indicating the transaction between the specified entities. Similarity, other compensation and transactional information may also be written in subsequent block 306 to create an immutable record.

It should be understood that several types of transactional or viewership data may be bundled into blocks and every block (other than the Genesis block) refers back to or is linked to a prior block in the chain to maintain data integrity. For example block 312 may include a cryptographic hash value of the prior block (i.e., block 310). In turn, block 310 may also include a cryptographic hash value of the block 306. Consequently, once a block refers to a prior block (using the cryptographic hash), it becomes difficult to modify or tamper with the data (e.g., transaction details) because even a small modification to the data would effect a change in the hash value of the entire block. Moreover, given the distributed nature of the ledger across multiple viewer devices, each additional block increases the difficulty of tampering with the contents of an earlier block.

Identifiers used may be created through cryptography such as, for example, public key cryptography. The identifiers within block 302 may also represent the unique ID of a specific media viewers, entities, wallets, or the like. In this manner, viewership information and any related compensation from various media viewers may be aggregated and stored in blocks of the ledger.

In some cases, it may be possible for two media viewers to attempt to generate a block at the same time as indicated in blocks 306 and 308. This scenario may occur due to network latency indicating acceptance of block 306 into the blockchain. In this instance, one of the two viewers may be randomly accepted into the blockchain while the other block 308 is discarded from getting added to the blockchain and is termed an orphan block. Several other methods to avoid or mediate orphan blocks may be implemented.

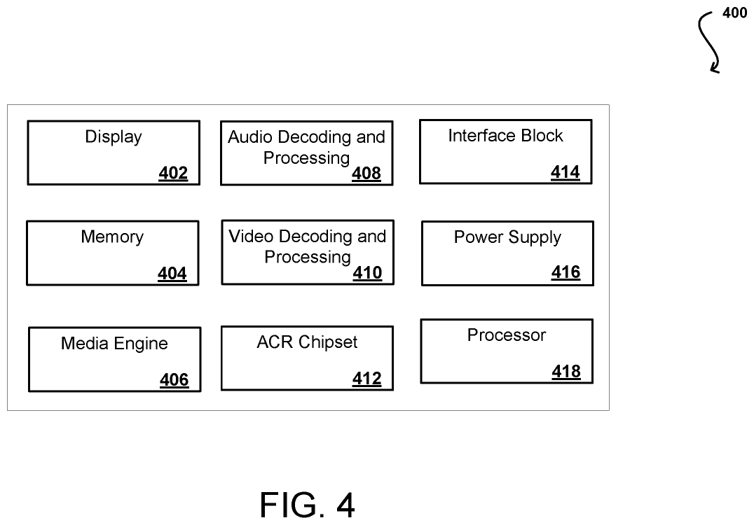

FIG. 4 illustrates an example computing device 400 that can be used to implement aspects of the various embodiments. Such a computing device may include display elements (e.g., display screens or projectors) for displaying or otherwise presenting consumer content. In various embodiments, the user device 400 may be a television, smart phone, computer, or the like as described in detail above. In various embodiments, the illustrated user device 400 includes a display 402. As will be appreciated, the display may enable the viewing of content on the user device 400. The display may be of a variety of types, such as liquid crystal, light emitting diode, plasma, electroluminescent, organic light emitting diode, quantum dot light emitting diodes, electronic paper, active-matrix organic light-emitting diode, and the like. The user device 400 further includes a memory 404. As would be apparent to one of ordinary skill in the art, the device can include many types of memory, data storage or computer-readable media, such as a first data storage for program instructions for execution by the at least one processor.

In various embodiments, the user device 400 includes a media engine 406. As used herein, the media engine 406 may include an integrated chipset or stored code to enable the application of various media via the user device 400. For example, the media engine 406 may include a user interface that the user interacts with when operating the user device 400. Further, the media interface 406 may enable interaction with various programs or applications, which may be stored on the memory 404. For example, the memory 404 may include various third party applications or programs that facilitate content delivery and display via the user device 400.

In various embodiments, the user device 400 further includes an audio decoding and processing module 408. The audio decoding and processing module 408 may further include speakers or other devices to project sound associated with the content displayed via the user device 400. Audio processing may include various processing features to enhance or otherwise adjust the user's auditory experience with the user device 400. For example, the audio processing may include feature such as surround-sound virtualization, bass enhancements, and the like. It should be appreciated that the audio decoding and processing module 408 may include various amplifiers, switches, transistors, and the like in order to control audio output. Users may be able to interact with the audio decoding and processing module 408 to manually make adjustments, such as increasing volume.

The illustrated embodiment further includes the video decoding and processing module 410. In various embodiments, the video decoding and processing module 410 includes components and algorithms to support multiple ATSC DTV formats, NTSC and PAL decoding, composite and S-Video inputs, and 2D adaptive filtering. Further, high definition and 3D adaptive filtering may also be supported via the video decoding and processing module 410. The video decoding and processing module 410 may include various performance characteristics, such as synchronization, blanking, and hosting of CPU interrupt and programmable logic I/O signals. Furthermore, the video decoding and processing module 410 may support input from a variety of high definition inputs, such as High Definition Media Interface and also receive information from streaming services, which may be distributed via an Internet network.

As described above, the illustrated user device 400 includes the ACR chipset 412, which enables an integrated ACR service to operate within the user device 400. In various embodiments, the ACR chipset 412 enables identification of content displayed on the user device 400 by video, audio, or watermark cues that are matched to a source database for reference and verification. In various embodiments, the ACR chipset 412 may include fingerprinting to facilitate content matching. The illustrated interface block 414 may include a variety of audio and/or video inputs, such as via a High Definition Media Interface, DVI, S-Video, VGA, or the like. Additionally, the interface block 414 may include a wired or wireless internet receiver. In various embodiments, the user device 400 further includes a power supply 416, which may include a receiver for power from an electrical outlet, a battery pack, various converters, and the like. The user device 400 further includes a processor 418 for executing instructions that can be stored on the memory 404.

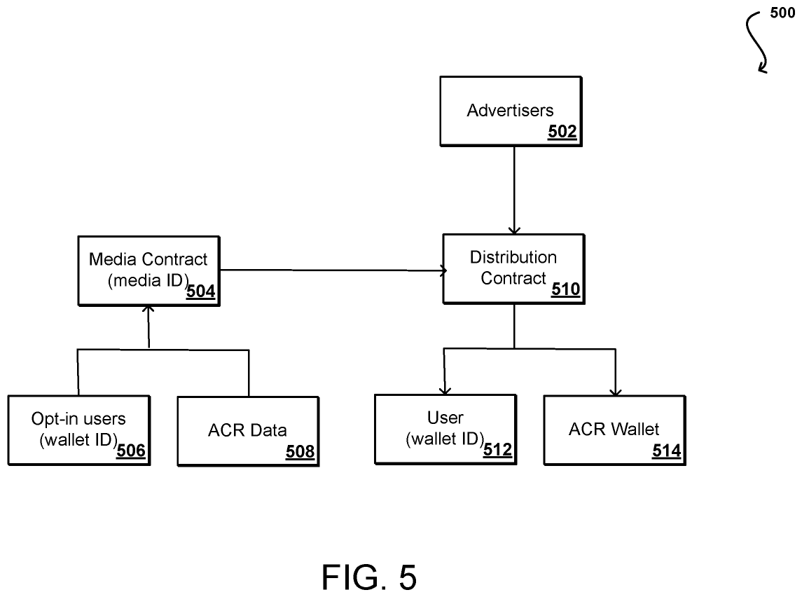

FIG. 5 illustrates an example system for managing viewer wallets that can be utilized in accordance with various embodiments. The system may include advertisers 502 seeking to purchase viewership data from distribution contract 510. Media Contracts 504 may include any content consumed in the ecosystem such as television shows, movies, songs, games, news, ads, or user generated view. Each piece of content may be associated with a unique content ID.

In one embodiment, media contract 504 may accept user data from an opted in user 506 (as identified by their walled ID) and pass that user data, including associated ACR data 508 to the distribution contract 510. Receipt of the media contract may trigger execution of the distribution contract to distribute tokens or coins according to any specified terms of the media contract. For example, distribution contract 510 may distribute currency to user wallet ID 506, 512 or ACR wallet 514. Tokens may be distributed to any other wallets as specified in distribution contract 510.

In another embodiment, distribution contract 510 may accept currency from advertisers 502 in exchange for access to user-viewership data, thus establishing a replenishable body of currency from which to compensate users for sharing their data. It should be noted that contracts above may be self-executing “smart” contracts represented as computer code, stored and replicated by a network of nodes (i.e., viewer devices) produce blocks or store transactional or viewership data on the distributed ledger.

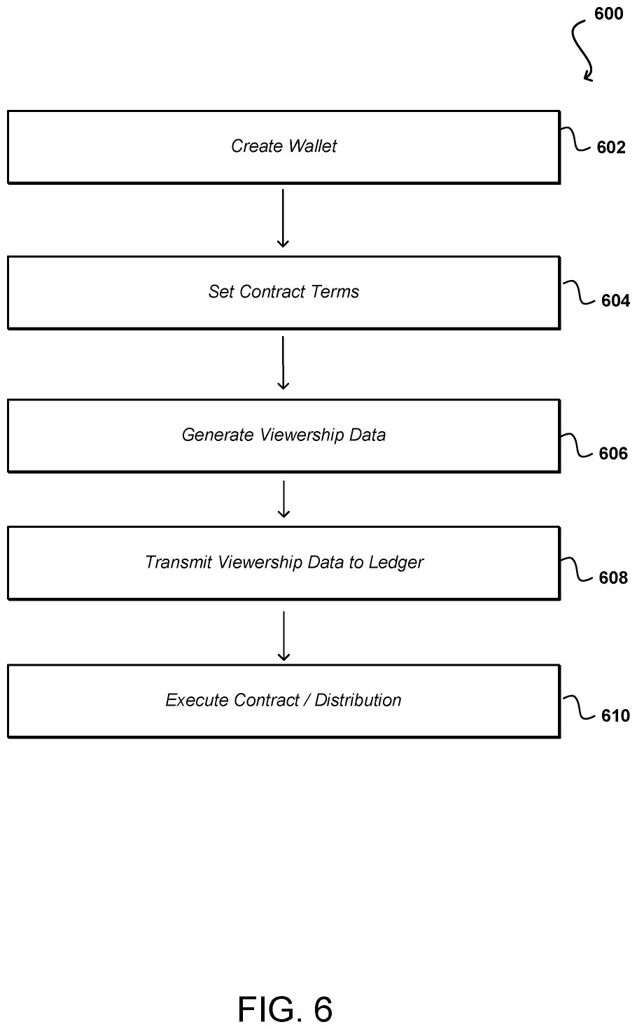

FIG. 6 illustrates an example currency flow that can be utilized in accordance with the various embodiments as discussed and suggested elsewhere herein. Using the VAT as an example, a user may create a wallet 602 associated with the VAT blockchain. The wallet may be created via a viewer device interface, website, or mobile app that enables the user to generate one or more unique VAT wallet addresses from which the user may send, receive, or record transactions on the blockchain. To associate this wallet with one or more media viewers, the user may be prompted to input unique codes displayed or labeled on specified viewer devices. The user may also desire to input personally identifiable information such as name, address, location, or age, into the mobile app.

While creating a wallet, the user may also establish individualized contract terms 604 by electing to share viewership data with third parties in exchange for units of tokens. The amount of tokens a user earns may depend on the level of data sharing the user permits per type or number of data customer. For example, a user may elect to share no viewership data, anonymized viewership data, or personalized viewership data with different data customers for predefined prices or time periods. Such information may be captured in the wallet interface and transcoded into a smart contract that resides on the blockchain.

As the user begins to generate viewership data 606 by consuming content on the device viewer, value (in units of VATs) begins to accrue, presuming the user has opted in to share some level of data. The overall value of the viewership data may also depend contextually on factors such as user privacy settings (i.e., amount of data user decides to share, the time/length of consumption, content type, demand for consumed content, or device (e.g., mobile, television, laptop, etc.) on which the content was consumed. Alternatively, the user may assign a predefined value amount to a unit of viewership data.

At defined intervals, the ACR may cryptographically hash the viewership data and transmit it for storage 606 in an entry on the blockchain. Certain information may be publicly available in the blockchain such as the transaction ID and details of the compensation contract required to access additional data. In some embodiments, the blockchain entry may include an identifier indicating only that a specific viewer or viewing device presented a specific instance of content at a particular time without disclosing any personally identifiable information.

Data customers (e.g., advertisers, publishers, etc.) to the extent approved by the user, may “buy” the data by transferring the disclosed value of the viewership data to compensation wallets associated with a particular contract. To ensure data integrity, data customers may compare the hashed output of the viewership data received with the hashed value of the viewership data maintained on the blockchain. Any difference in output would suggest that the data customer received a different dataset than stored on the blockchain.

Receipt of tokens from a data customer may execute or trigger a smart contract 610 to release granular viewership information to the customer and distribute the earned tokens to wallet addresses defined within the contract. For example, the smart contract may be configured to distribute portions of the amount to the user, the media device manufacturer or the ACR service provider according to terms of the distribution contract. As users accumulate tokens, they may swap them for other cryptocurrencies, use them to pay for premium content, or convert them to fiat currency in open exchange markets. Accordingly, users may accumulate varying amounts of tokens by consuming content and sharing varying levels of viewership data with third parties.

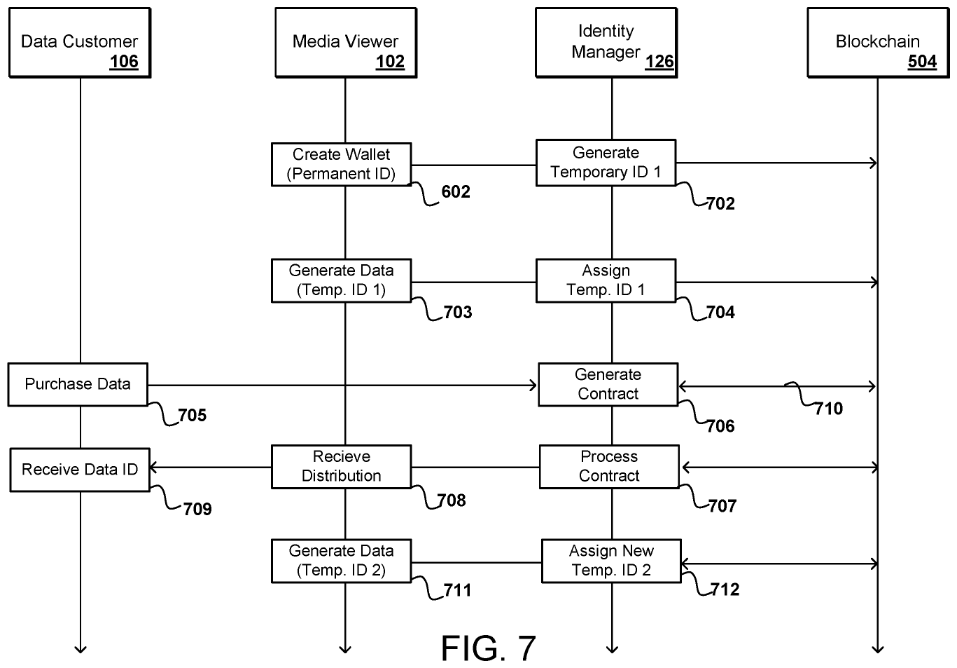

FIG. 7 illustrates a diagram of an example process that may be implemented according to certain example embodiments. FIG. 7 includes data customer 106, media viewer 102 for generating viewership data, identity manager 126 for managing temporary identifiers, and a distributed ledger, blockchain 504.

In one embodiment, one or more users associated with viewer 102 may create an individual wallet 602 as previously disclosed. Identity manager 126 may then generate one or more temporary IDs linked to the generated wallet or to the physical viewer 102. A physical identifier may be the GUID of viewer 102, whereas a temporary identifier may be randomly generated (i.e., hash of a GUID). As viewer 102 generates viewership data, identity manager 126 appends a temporary ID 704 to such data before storing the transaction, which includes the viewership data and associated temporary identifiers, to blockchain 504. By so doing, aggregate viewership data from viewer 102 may be publicly accessible from blockchain 504, without revealing granular identifiers (e.g., device type, user information, geographical information, etc.) of the data source

In some embodiments, data customer 106 may desire to purchase viewership data generated by viewer 102 that is stored within block chain 504. Identity manager 126 and data customer 106 may enter into a contract describing the terms upon which customer 106 may acquire the data. Upon execution of the contract, identity manager 126 may process the contract, which may include distributing a portion of the payment received from data customer 106 (i.e., VAT) to the user wallet associated with the data 708, and transmitting to customer 106 the temporary identifiers associated with viewership data from viewer 102. Using the temporary identifiers, customer 102 may query blockchain 504 for data linked to the temporary identifiers per terms of the contract. The terms and fulfillment of the contract may also be stored 710 on block chain 504.

Upon termination or breach of the contract, identity manager 126 may assign a new temporary ID 712 to viewership data streamed from viewer 102. Thus, although data from viewer 102 would still be available on the ledger, data customer 106 would no longer be able to access that data because the temporary IDs would be different than what was used previously under the now-expired contract. This ensures that data customer 106 only receives data for which compensation has been provided over the time period established under an agreement.

It should be understood that the order of activity as depicted in the figures above are conceptual and may deviate without departing from the various embodiments disclosed. Moreover, the specification and drawings are, accordingly, to be regarded in an illustrative rather than a restrictive sense. It will, however, be evident that various modifications and changes may be made thereunto without departing from the broader spirit and scope of the invention.

What is claimed is:

1. A method comprising:
obtaining, from a media device, viewership data for a viewer;
receiving a request for access to the viewership data according to a set of terms;
storing the viewership data and the set of terms to at least one public, distributed ledger;
receiving information for a transaction involving the viewership data according to the set of terms; and
storing information for the transaction to the at least one public, distributed ledger.

2. The method of claim 1, comprising:
determining that the transaction satisfies the set of terms before allowing the transaction to proceed.

3. The method of claim 1, comprising:
determining an identity of the viewer;
mapping the identity of the viewer to a temporary identifier; and
storing the temporary identify with the viewership data in the at least one public, distributed ledger without other identifying information for the viewer.

4. The method of claim 1, comprising:
providing cryptocurrency as compensation for the transaction; and
storing information for the cryptocurrency to the at least one public, distributed ledger.

5. A method comprising:
receiving a first identifier and viewership data from a media device;
generating a second identifier based on at least one of the first identifier and the viewership data;
associating the second identifier with the viewership data;
storing the viewership data associated with the second identifier on a distributed ledger;
receiving a request for the first identifier of the stored viewership data associated with the second identifier;
transmitting the first identifier of the stored viewership data associated with the second identifier;
generating a third identifier and associating the third identifier with the viewership data; and
storing the request and viewership data associated with the third identifier on the distributed ledger.

6. The method of claim 5, wherein the first identifier corresponds to a wallet for receiving a cryptocurrency, the wallet belong to a user operating the media device.

7. The method of claim 5, further comprising:
receiving a payment, in response to transmitting the first identifier of the stored viewership data;
transmitting at least a portion of the payment to a user associated with the first identifier; and
storing the payment and the first identifier on the distributed ledger.

8. The method of claim 5, further comprising:
determining an identity of a viewer of the media device; and
mapping the identity of the viewer to the second identifier.

9. The method of claim 5, further comprising:
determining an identify of a requestor, the requestor transmitting the request for the first identifier of the stored viewership data; and
determining a permission, assigned by a user associated with the first identifier device, authorizes transmission to the requestor before transmitting the first identifier of the stored viewership data associated with the second identifier.

10. The method of claim 5, further comprising:
determining a specified level of access associated with at least one of the first identifier, the second identifier, or the third identifier; and
determining the request is authorized by the specified level of access.

11. The method of claim 5, wherein the distributed ledger includes at least a set of terms associated with requests, the method further comprising:
determining the request satisfies the set of terms before allowing the transaction to proceed.

12. The method of claim 5, wherein storing the viewership data associated with the second identifier does not include other identifying information for a user associated with the second identifier.

13. The method of claim 5, further comprising:
transmitting at least a portion of the viewership data to a marketplace.

14. A system, comprising:
at least one processor; and
memory including instructions that, when executed by the at least one processor, cause the system to:
receive a first identifier and viewership data from a media device;
generate a second identifier based on at least one of the first identifier and the viewership data;
associate the second identifier with the viewership data;
store the viewership data associated with the second identifier on a distributed ledger;
receive a request for the first identifier of the stored viewership data associated with the second identifier;
transmit the first identifier of the stored viewership data associated with the second identifier;
generate a third identifier and associate the third identifier with the viewership data; and
store the request and viewership data associated with the third identifier on the distributed ledger.

15. The system of claim 14, wherein the instructions when executed further cause the system to:
receive a payment, in response to transmitting the first identifier of the stored viewership data;
transmit at least a portion of the payment to a user associated with the first identifier; and
store the payment and the first identifier on the distributed ledger.

16. The system of claim 14, wherein the instructions when executed further cause the system to:
determine an identity of a viewer of the media device; and
map the identity of the viewer to the second identifier.

17. The system of claim 14, wherein the instructions when executed further cause the system to:
determine an identify of a requestor, the requestor transmitting the request for the first identifier of the stored viewership data; and
determine a permission, assigned by a user associated with the first identifier device, authorizes transmission to the requestor before transmitting the first identifier of the stored viewership data associated with the second identifier.

18. The system of claim 14, wherein the instructions when executed further cause the system to:
determine a specified level of access associated with at least one of the first identifier, the second identifier, or the third identifier; and
determine the request is authorized by the specified level of access.

19. The system of claim 15, wherein the distributed ledger includes at least a set of terms associated with requests, and wherein the instructions when executed further cause the system to:
determine the request satisfies the set of terms before allowing the transaction to proceed.

20. The system of claim 15, wherein storing the viewership data associated with the second identifier does not include other identifying information for a user associated with the second identifier.
